(19) United States
(12) Patent Application Publication
(10) Pub. No.: US 2022/0138831 A1
(43) Pub. Date: May 5, 2022

(54) Method of Providing Fashion Item Recommendation Service Using User's Body Type and Purchase History

(71) Applicant: Odd Concepts Inc., Seoul (KR)

(72) Inventor: Ae Ri YOO, Gyeonggi-do (KR)

(21) Appl. No.: 17/431,696

(22) PCT Filed: Feb. 20, 2020
(86) PCT No.: PCT/KR2020/002301

§ 371 Date: Aug. 17, 2021

(30) Foreign Application Priority Data
Feb. 19, 2019 (KR) 10-2019-0019241

(51) Int. Cl. G06Q 30/06; G06Q 30/02

(52) U.S. Cl. CPC G06Q 30/0631; G06Q 30/0204

(57) ABSTRACT

The present invention relates to a method of providing a fashion item recommendation service to a user using a service server. Specifically, the method of providing a fashion item recommendation service to a user using a service server includes: collecting histories of purchases through an online-shop and generating a user preference database by clustering user body type information and online-shop information from the purchase histories; when receiving a request for a recommendation service from a specific user, checking online-shop information corresponding to the recommendation service based on a style label expressing a human feeling as computer-recognizable data; performing collaborative filtering in the user preference database based on a fashion item size range determined based on the checked online-shop information and the user body type information to select at least one candidate item; and setting a priority for the at least one selected candidate item based on purchase patterns of users having a body type similar to a body type of the specific user among users that have used the checked online-shop, and providing a recommended product according to the set priority.

### TECHNICAL FIELD

The present invention relates to a method of providing a fashion item recommendation service to a user, and more particularly, to a method of providing a fashion item recommendation service using a user's body type and purchase history.

### BACKGROUND ART

In the background of the recently increased wired and wireless Internet environment, commerce such as public relations and sales using online is being activated. In this regard, when buyers find a product they like while searching for a magazine, blog, or YouTube video on a desktop or mobile terminal connected to the Internet, they search for a product name, etc. and make a purchase. An example is the case where the name of a bag that a famous actress had carried at the airport or the name of a childcare item that has been shown in an entertainment program rank high in real-time search terms on portal sites. However, in this case, the user has to separately open a web page for the search and search for a product name, manufacturer, vendor, etc., thus causing an inconvenience in that it is not easy to search unless clear information about them is already known.

On the other hand, sellers spend a lot of money on media sponsorship and online reviews collection in addition to commercial advertisements to promote their products. This is because word-of-mouth online recently acts as an important variable in product sales. However, it is often not possible to disclose shopping information, such as product name and vendor, despite the cost of publicity. This is because indirect advertising issues may arise as it is not possible to individually obtain prior approval from media viewers for product name exposure.

As described above, there is a need for both users and sellers to provide shopping information in a more intuitive user interface (UI) environment for online product images.

### SUMMARY OF INVENTION

### Technical Problem

Based on the above discussion, hereinafter, it is intended to provide a fashion item recommendation service using the user's body type and purchase history.

The technical problems to be solved by the present invention are not limited to the aforementioned problems, and any other technical problems not mentioned herein will be clearly understood from the following description by those skilled in the art to which the present invention pertains.

### Solution to Problem

According to an aspect of the present invention for solving the above-mentioned problems, a method of providing a fashion item recommendation service to a user using a service server includes: collecting purchase histories through an online-shop and generating a user preference database by clustering user body type information and online-shop information from the purchase histories; when receiving a request for a recommendation service from a specific user, checking online-shop information corresponding to the recommendation service based on a style label expressing a human feeling as computer-recognizable data; performing collaborative filtering in the user preference database based on a fashion item size range determined based on the checked online-shop information and the user body type information to select at least one candidate item; and setting a priority for the at least one selected candidate item based on purchase patterns of users having a body type similar to a body type of the specific user among users that have used the checked online-shop and providing a recommended product according to the set priority.

Further, the method may further include: when it is determined to purchase the recommended product, transmitting purchase information to an online-shop for the recommended product and updating user body type information and online-shop information extracted from the purchase information in the user preference database.

Further, the method may further include: when receiving the request for the recommendation service, providing a coordination item by using a style database including style images from which the style label is extracted and a product database configured by indexing a label extracted from contents of products based on at least one of a product clicked by a user, a product purchased by a user, or a product in a user's shopping cart, and the coordination item may be provided together with a label of an item of another category determined from a style image including an item similar to the product purchased by the user, or may be provided together with a coupon applicable when being purchased together with the product in the shopping cart. Further, the coordination item may be arranged and provided according to the priority set according to the purchase patterns of the users, based on the size range of the fashion items.

Further, the user preference database may be updated by converting review data of users that have used the checked online-shop into computer-readable data.

The online-shop information may be clustered in the user preference database in a manner of being matched with a style label determined according to proportions of labels extracted from products sold in the online-shop.

### Advantageous Effects of Invention

According to the embodiments of the present invention, it is possible to efficiently provide a fashion item recommendation service using a user's body type and purchase history.

The effects of the present invention are not limited to the aforementioned effects, and any other effects not mentioned herein will be clearly understood from the following description by those skilled in the art.

### BRIEF DESCRIPTION OF THE DRAWINGS

The accompanying drawings, which are included as part of the detailed description for helping the understanding of the present invention, provide embodiments of the present invention and describe the technical spirit of the present invention together with the detailed description.

FIG. 1 is a reference diagram for describing a method of providing a fashion item recommendation service to a user using a service server according to an embodiment of the present invention.

FIG. 2 is a flowchart for providing a recommendation service in a service server according to the present invention.

### DESCRIPTION OF EMBODIMENTS

The present invention is not limited to the description of the embodiments described below, and it is obvious that various modifications may be made without departing from the technical gist of the present invention. In describing the embodiments, descriptions of technical contents that are widely known in the technical field to which the present invention pertains and are not directly related to the technical gist of the present invention will be omitted.

Hereinafter, it is assumed that a user device displaying product information is a mobile device, but the present invention is not limited thereto. That is, in the present invention, a user device should be understood as a concept including all types of electronic devices capable of requesting a search and displaying advertisement information, such as a desktop, a smart phone, and a tablet PC.

It should also be noted that the concept of products herein is not limited to tangible products. In other words, the product is to be understood herein as a concept that includes intangible services, which are sellable, as well as tangible products.

As used herein, the term “displayed page in an electronic device” can be understood herein as a concept that includes a screen loaded on an electronic device so as to be immediately displayed on a screen as the user scrolls and/or content within the screen. For example, the entire execution screen of an application that is extended in a horizontal or vertical direction on the display of the mobile device and displayed according to a user's scrolling may be included in the concept of the page, and a screen in camera roll may also be included in the concept of the page.

Meanwhile, in the accompanying drawings, the same components are represented by the same reference numerals.

In the accompanying drawings, some components may be exaggerated, omitted, or schematically shown. This is to clearly describe the gist of the present invention by omitting unnecessary descriptions not related to the gist of the present invention.

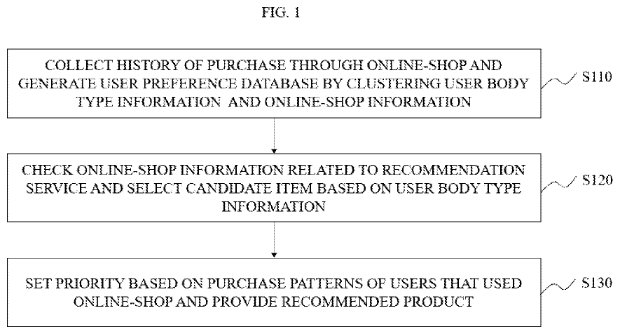

FIG. 1 is a reference diagram for describing a method of providing a fashion item recommendation service to a user using a service server according to an embodiment of the present invention.

A service server collects histories of purchases through an online-shop and clusters user body type information and online-shop information from the purchase histories to generate a user preference database (S110).

The service server may extract user body type information from not only the history of purchasing products from online-shops by multiple users through the service server, but also purchase histories of users, products viewed by users, or inquiry histories of users, which are obtained from online-shops. Here, the user body type information may include formal data such as colors, patterns, shapes, and sizes from products purchased by a user, and data obtained by formulating informal data such as size review information and fit review information. For example, review data such as size review information, fit review information, and rating of users/buyers for a specific product in a specific online-shop may be converted into computer-readable data such as labels and vectors and included in the user body type information. In addition, the service server according to the present invention may create a user preference database without a user's input, but advanced search may be possible or service may be upgraded when additional data such as a user's review is received through an arbitrary input from a user.

Therefore, when data such as purchase history through a specific online-shop is accumulated, user body type information is further subdivided so that when a recommendation service is requested, the products that users of the corresponding online-shop mainly purchased may be preferentially sorted.

Accordingly, the service server may cluster a body size range based on information such as the size of each products purchased by other users in the online-shop, without directly receiving an input from a specific user. That is, the service server may perform clustering for a specific online-shop at the top of a classification structure, and perform classification or regression in the size information range at the bottom of the classification structure. The service server may recognize a class or type of input data using the classification structure. Through clustering, the depth of the entire classification structure may be reduced and the search speed may be increased. For example, the service server may improve a classification rate and a regression accuracy by ensemble by configuring the top of the classification structure with a small number and configuring the bottom of the classification structure with a large number. For example, the service server may cluster training data selected based on global shape parameters. The global shape parameters may be used to determine global characteristics of the selected training data. The service server may create clusters that are a set of training data through clustering. In particular, the service server may select a global shape parameter to be tested from among heterogeneous global shape parameters. Thereafter, the service server may determine a parameter value for the training data using the selected global shape parameter. The service server may determine parameter values for a plurality of global shape parameters. The service server may normalize the determined plurality of parameter values (Parameter Value Normalization). The service server may normalize the sizes of the parameter values to evenly adjust the scales of the parameter values. Thereafter, the service server may configure a parameter vector for each individual training data. The service server may randomly generate a threshold value and divide the parameter vectors into a plurality of data sets based on the generated threshold value. The threshold value may be generated in an arbitrary number. Accordingly, the service server may determine the mean and standard deviation for the plurality of data sets, and determine a separation between the data sets using the determined mean and standard deviation information. The separation between the data sets indicates a degree of separation between data sets from each other. Accordingly, the service server may determine whether the determined separation satisfies a preset condition, and store division information according to a result of the determination. For example, when the currently determined separation is the largest among a plurality of separations determined based on other global shape parameters, the service server may determine that the separation satisfies a preset condition. The division information may include information about a global shape parameter used to generate a plurality of clusters and information about threshold values used to divide a parameter vectors into a plurality of data sets.

Here, since clustering is performed on the online-shop at the top of the classification structure, the user preference database may be classified based on a style label that expresses a human feeling as computer-recognizable data such as #office look, #cute look, and #sexy look for a specific online-shop. For example, clustering may be performed in the user preference database in a manner of being matched with a style label determined according to the proportions of labels extracted from products sold in the online-shop.

Accordingly, when the service server receives the request for recommendation service, the service server may first check the online-shop information corresponding to the recommendation service based on the style label that expresses the human feeling as computer-recognizable data, and select a candidate item based on the user body type information of the user who requested the recommendation service (S120). In this case, the service server may perform collaborative filtering in the user preference database based on a fashion item size range determined based on the checked online-shop information and the user body type information of the user who requested the recommendation service to select at least one candidate item.

Furthermore, when the service server cannot determine a fashion item suitable for the recommendation service in the specific online-shop (e.g., a case where the style label is inappropriate) even if a request for the recommendation service from a user who mainly uses the specific online-shop (e.g., Shop #A) is received, the service server may provide the recommendation service to the user by using another online-shop (e.g., Shop #B) having a style label appropriate for the corresponding recommendation service.

The collaborative filtering in the present invention refers to a process of automatically predicting a fashion item suitable for a buyer's preference according to not only user body type information including color, pattern, shape, size, or the like of purchased products, which is obtained from users who purchased products through multiple online-shops, but also information such as size reviews information and fit reviews information. Therefore, it is possible to identify users having similar colors, patterns, and labels in preference and interest based on the preference and interest expression of users with a specific size range in a specific online-shop, and recommend products that have not yet been purchased with respect to the identified users or related products according to the classified customer's taste or lifestyle, rather than simply determining the average preference based on the sales volume of purchased products. That is, the service server of the present invention has a feature of performing collaborative filtering based on size rather than simple collaborative filtering when a user requests a recommendation service by clustering online-shop information and user body type information.

In addition, when receiving a request for a recommendation service, the service server according to the present invention may provide a coordination item by using a style database including style images from which the style labels are extracted and a product database configured by indexing labels extracted from the contents of the products based on at least one of a product clicked by a user, a product purchased by a user, or a product in a user's shopping cart. The coordination item may be provided together with a label of an item of another category determined from a style image including an item similar to the product purchased by the user, or may be provided together with a coupon applicable when being purchased together with a product in the shopping cart.

Specifically, when the user who requested the recommendation service clicks on a product page provided through the service server or coordinates based on the product purchased or in the shopping cart, a well-matched product may be further provided. For example, when a coordination item is provided based on an existing purchased product, a recommended coordination item may be provided according to a label of a product that can be matched together in the purchase history. Accordingly, since the user is first recommended a suitable product when the user is utilizing a purchased product, there is an advantage in that it is easy to make additional purchases. As another example, when a recommendation service is provided based on a shopping cart product, a coupon that may be used for purchases together with the shopping cart product may be provided together. These coupons may be applied automatically even without a user's separate selection.

Accordingly, even in the case of coordination items, the coordination items may be arranged and provided according to the priority set according to the purchase patterns of users that have used the online-shop, based on the user's fashion item size range. For example, when a coordination item is provided along with a request for a recommendation service, when a product that well matches a product of interest is recommended, products that people who have a body type similar to that of the user who requested the recommendation service have mainly purchased may be preferentially recommended.

Therefore, when a photo of a specific fashion item is extracted based on a specific online-shop and size body type information, the service server may provide a recommended item of the same fashion category or recommend and provide a different category item as a coordination item suitable for the specific fashion item.

In the present invention, the style database may include information on fashion images that can be referred to for a fashion style and coordination of a plurality of items among images collected on the web. The style database may include, among images collected online, an image in which a plurality of fashion items are well matched (hereinafter, referred to as a style image) and classification information on the style image. A style image according to an embodiment of the present invention is image data generated through combination of a plurality of fashion items in advance by a professional or semi-professional, and examples thereof may include fashion catalogs that can be collected on the web, fashion magazine pictorial images, fashion show shooting images, idol costume images, costume images from certain dramas or movies, social media, blog celebrity clothing images, street fashion images from fashion magazines, and images in which fashion items are coordinated with other items for sale.

Accordingly, the style image is stored in the style database according to an embodiment of the present invention, and may be used to determine other items that go well with a particular item. Accordingly, the style image may be used as a reference material based on which the computer can understand the human feeling of “going well” in general. Since “going well” with an arbitrary item is human feeling, a machine learning framework trained about matching multiple fashion items is required for a computer to recommend another item that “goes well with” a certain item without human intervention. To this end, the service server according to an embodiment of the present invention may collect a style image in which a plurality of fashion items are matched by a professional or semi-professional and worn by a person and may generate a style database therefrom. Furthermore, the service server may train the framework by applying the style database to the machine learning framework. For example, the machine learning framework that has learned a large number of style images in which a blue shirt and a brown tie are matched will be able to recommend a brown tie as a coordination item for a request associated with a blue shirt.

Also, in order to configure the style database, the service server may collect style images online. For example, the service server may collect a list of web addresses of fashion magazines, fashion brands, drama production companies, celebrity agencies, social media, online stores, and the like, and collect image information included in web sites through URL tracking by checking the web sites.

Alternatively, the style database may include fashion items extracted from the above-described user images. In this case, when a link is made through a web page or a purchase is made with respect to the extracted fashion item, points for material compensation for the user related to the user image may be set. This is defined as a link point in the present invention, and may be used to compensate the user in various forms such as points and mileage.

On the other hand, the service server according to an embodiment of the present invention may collect and index images from websites such as fashion magazines, fashion brands, drama production companies, celebrity agencies, social media, online stores, or the like, but image information may be separately provided along with index information from affiliated companies.

Accordingly, the service server may filter out images inappropriate for style recommendation among the collected images. For example, the service server may filter out the remaining images while leaving only images including a human-shaped object and a plurality of fashion items among the collected images.

Since style images are used to determine other items that can be coordinated with a requested item, it is appropriate to filter out images with a single fashion item. Furthermore, constructing a database with images of a person directly wearing a plurality of fashion items may be more useful than images of fashion items themselves. Therefore, the service server according to the embodiment of the present invention may determine style images to be included in the style database by leaving only the images containing a human-shaped object and a plurality of fashion items and filtering out the remaining images.

Thereafter, the service server may process the features of a fashion item object image included in the style image. More specifically, the service server may extract image features of the fashion item object included in the style image, generate feature values of the fashion item object by expressing the feature information as a vector value, and index feature information of the images.

Furthermore, the service server according to an embodiment of the present invention may extract a style label from a style image and cluster style images based on the style label. It is appropriate for the style label to be extracted as those related to the look and feel of the fashion item, such as the appearance and feel of the fashion item, and the trend. According to a preferred embodiment of the present invention, it is possible to extract a label for a feeling that a person can feel from the appearance of a single fashion item included in a style image or a combination of a plurality of items, and use the label as a style label. For example, celebrity look, magazine look, summer look, feminine look, sexy look, office look, drama look, Chanel look, or the like may be exemplified as style labels.

According to an embodiment of the present invention, the service server may define a style label in advance, generate a neural network model that learned the characteristics of images corresponding to the style label, classify an object in the style image, and extract the style label for a corresponding object. In this case, the service server may assign a corresponding label to an image that matches a specific pattern with an arbitrary probability through the neural network model that has learned a pattern of an image corresponding to each label.

According to another embodiment of the present invention, the service server may learn the characteristics of images corresponding to each style label to form an initial neural network model, and apply a large quantity of style image objects to the neural network model to more precisely extend the neural network model.

Meanwhile, according to still another embodiment of the present invention, the service server may apply style images to the neural network model with a hierarchical structure having a plurality of layers without separate learning of labels. Furthermore, it is possible to assign a weight to the feature information of the style image at the request of a corresponding layer, cluster product images using the processed feature information, and give a clustered image group a label, which is interpreted ex post, such as celebrity look, magazine look, summer look, feminine look, sexy look, office look, drama look, Chanel look, or the like.

Accordingly, the service server may cluster style images using the style label and generate a plurality of style books. This is intended to be provided as a reference to users. A user may browse a specific style book among the plurality of style books provided by the service server and find a favorite item, and may request a search for product information for a corresponding item.

Meanwhile, the service server may pre-classify items having a very high appearance rate, such as white shirts, jeans, and black skirts. For example, since jeans are a basic item in fashion, their appearance rate in style images is very high. Therefore, even if the user inquires about any item, the probability that jeans will be matched as a coordination item will be significantly higher than that of other items.

Therefore, the service server according to the embodiment of the present invention may pre-classify items having a very high appearance rate in the style images as buzz items, and create style books with different versions, one of the style books including the buzz item and the other not including the buzz item.

According to another embodiment of the present invention, the buzz item may be classified by reflecting time information. For example, in consideration of the fashion cycle of fashion items, items that are in fashion for a short time for one or two months and disappear, items that return every season, and items that are continuously popular for a certain period of time may be considered. Accordingly, when time information is reflected in the classification of buzz items and the appearance rate of a specific fashion item is very high for a certain period, the item may be classified as a buzz item together with information about the corresponding period. When the buzz items are classified in this way, in the subsequent item recommendation phase, there is an effect that the recommendation target item may be recommended in consideration of whether the item to be recommended is in trend or not related to the trend.

That is, the service server according to the present invention may process a specific fashion item object included in the received request and search the style database based on image similarity. That is, the service server may search for similar items in the style database by processing an image object specified as a search target.

To this end, the service server may extract the feature of the search target image object and index specific information of the images for the efficiency of search.

Furthermore, the service server according to an embodiment of the present invention may extract a label and/or category information on the meaning of the search target object image by applying the machine learning technique used to construct the product image database to the processed search target object image. The label may be expressed as an abstracted value, but may be expressed in text form by interpreting the abstracted value.

For example, the service server according to an embodiment of the present invention may extract labels for women, one-piece dress, sleeveless, linen, white, and casual look from a request object image. In this case, the service server may use the labels for women and one-piece dress as category information of the request object image, and the labels for sleeveless, linen, white, and casual look as label information for describing features of the object image outside the category.

Thereafter, the service server may search the style database based on the similarity of the request object image. The reason for this is to search for an item similar to a request image in the style database, and check other items that are matched with the similar items in a style image. For example, the service server may calculate the similarity between the feature values of the request object image and the fashion item object images included in the style image, and identify an item whose similarity is within a preset range.

Furthermore, the service server according to the embodiment of the present invention may process the feature values of the request image by reflecting the weights required by the plurality of layers of an artificial neural network model for the machine learning configured for the product database, select at least one fashion item group included in the style book having a distance value within a predetermined range with respect to the request image, and determine items belonging to the group as similar items.

On the other hand, according to a preferred embodiment of the present invention, the service server may search the style database based on the similarity of the request image to determine the similar item, and in this case, the label and category information extracted from the images may be used to increase the accuracy of the image search.

For example, the service server may calculate the similarity between the feature values of a request image and a style database image, and exclude products of which the label and/or category information does not match the label and/or the category information of the request image, among products with the similarity lager than or equal to a similarity in a predetermined range to determine similar items.

As another example, the service server may calculate an item similarity only for a style book having the label and/or the category information matching the label and/or category information of the request image.

For example, the service server according to an embodiment of the present invention may extract a style label from the request image, and specify a similar item in a style book matching the label based on the image similarity with the request. Of course, the service server may specify similar items based on the image similarity with the request image in the style database without extracting a separate label from the request image.

For example, if there is a leaf pattern dress in the image included in the request, the service server may extract a label of tropical from the request. Thereafter, the service server may specify a similar item having a similarity within a preset range to the leaf pattern dress in the clustered style book with the label of tropical.

Thereafter, the service server may provide a style image, in which the similar item found from the style book is included and the similar item is well-matched with other fashion items, to the user device. In the above example with the leaf pattern dress, a style image in which a straw hat, a rattan bag, and the like are matched with the leaf pattern dress may be provided to the user.

Accordingly, when an item similar to a specific fashion item is found from the style database, the service server may determine a coordination item by checking a fashion item of another category included in the style image and matched with the similar item.

That is, a specific fashion item inquired by the user may be searched for in the style database based on an image similarity, and a fashion item of another category matched with the similar item in a style image including the similar item may be considered as a recommended item. This is because the service server according to the embodiment of the present invention has learned that other items matched with the request item in the style image are well matched.

When the coordination item is determined using the style database, the service server may determine a product similar to the coordination item from the product database as a recommended product.

The product database may include detailed product information such as country of origin, size, vendor, and wearing shot of products which are sold in an online market, and has a characteristic in that product information is configured based on the image of the product.

That is, the service server may collect product information on products sold in any online market as well as product information of a pre-affiliated online market. For example, the service server may include a crawler, a parser, and an indexer to collect web documents of online stores, and access product images and text information such as product names, and prices, included in the web documents.

For example, the crawler may collect a list of web addresses of online stores, identify websites and track links to transmit data related to product information to the service server. In this case, the parser may extract product information such as product images, product prices, and product names included in the page by interpreting the web documents collected during the crawling process, and the indexer may index relevant locations and meaning.

Meanwhile, although the service server according to the embodiment of the present invention may collect and index the product information from the websites of any online stores, the service server may receive product information with a predetermined format from an affiliated market.

The service server may process the product images. The reason for this is to determine a recommended item based on similarity between the product images without depending on text information such as a brand name or a sales category.

According to the embodiment of the present invention, the recommended item may be determined based on the similarity of the product images, but the present invention is not limited thereto. In other words, depending on the implementations, a product image as well as a product name or a sales category may be used as a single or auxiliary request. For this purpose, the service server may construct a database by indexing text information such as a product name and a product category in addition to an image of a product.

According to a preferred embodiment of the present invention, the service server may extract the features of product images and index feature information of the images for the efficiency of search.

More specifically, the service server may detect feature regions of the product images (Interest Point Detection). The feature region refers to a main region from which a descriptor for a feature of an image for determining whether images are identical or similar to each other, that is, a feature descriptor is extracted.

According to an embodiment of the present invention, such a feature region is contours included in an image, angles such as corners among the contours, blobs that are distinct from surrounding areas, regions that are invariant or covariant depending on the deformation of the image, or poles with features that are darker or brighter than the surrounding brightness and may target a patch (fragment) of the image or the entire image.

Furthermore, the service server may extract a feature descriptor from the feature region (Descriptor Extraction). The feature descriptor is a representation of the features of an image as a vector value.

According to an embodiment of the present invention, the feature descriptor may be calculated using the position of the feature region for a corresponding image, or the brightness, color, sharpness, gradient, scale, or pattern information of the feature region. For example, the feature descriptor may be calculated by converting the brightness value, the change value of the brightness, or the distribution value of the feature region into a vector.

Meanwhile, according to an embodiment of the present invention, the feature descriptor for the image may be expressed by not only a local descriptor based on the feature region, but also a global descriptor, a frequency descriptor, a binary descriptor, or a neural network descriptor.

More specifically, the feature descriptor may include a global descriptor which converts brightness, color, sharpness, gradient, scale, and pattern information of each regions obtained by dividing the entire image or an image according to an arbitrary criterion or of the feature region into vector values for extraction.

For example, the feature descriptor may include a frequency descriptor that converts the number of times a specific descriptor is included in the image, the number of times a global feature such as generally-defined color palette is included in the image, or the like into a vector value for extraction, a binary descriptor that extracts whether each descriptor is included in the image and whether the size of each of elements constituting a descriptor is larger or smaller than a specific value in units of bits and converts it to an integer type, and a neural network descriptor that extracts image information used for learning at a layer of neural network or for classification.

Furthermore, according to an embodiment of the present invention, the feature information vector extracted from the product image may be converted into a low-dimensional vector. For example, the feature information extracted through the artificial neural network corresponds to high-dimensional vector information of 40000-dimensions, and it is appropriate to convert the feature information into a low-dimensional vector in an appropriate range in consideration of the resources required for the search.

The conversion of the feature information vector may use various dimensional reduction algorithms such as PCA and ZCA, and the feature information converted into a low-dimensional vector may be indexed into a corresponding product image.

Furthermore, the service server according to the embodiment of the present invention may extract a label for the meaning of the image by applying a machine learning approach based on the product image. The label may be expressed as an abstracted value, but may be expressed in text form by interpreting the abstracted value.

More specifically, the service server may define a label in advance, generate a neural network model that learned the features of images corresponding to the label, classify an object in the product image, and extract the label for a corresponding object. In this case, the service server may use the neural network model that has learned a pattern of an image corresponding to each label to assign the corresponding label to an image that matches a specific pattern with an arbitrary probability.

Also, the service server may learn the characteristics of images corresponding to each label to form an initial neural network model, and apply a large quantity of product image objects to the neural network model to more precisely extend the neural network model. Furthermore, when a corresponding product is not included in any group, the service server may create a new group including the corresponding product.

Accordingly, the service server may define labels that can be used as meta information for products in advance, such as women's bottoms, skirts, dresses, short sleeves, long sleeves, patterns, materials, colors, abstract feelings (innocent, chic, vintage, etc.), generate a neural network model that has learned the features of images corresponding to the label, and extract a label for an advertisement target product image by applying the neural network model to an advertiser's product image.

Alternatively, the service server may apply product images to a neural network model with a hierarchical structure having a plurality of layers without separate learning of labels. Furthermore, weights may be assigned to feature information of a product image according to a request of a corresponding layer, and the product images may be clustered using the processed feature information.

In this case, further analysis may be necessary to check whether the corresponding images are clustered according to a certain attribute of the feature value, that is, to connect the result of clustering of the images to a concept that can be actually recognized by a human being. For example, when the service server classifies products into three groups through image processing, and extracts label A for the features of the first group, label B for the features of the second group, and label C for the features of the third group, it is necessary to be interpreted ex post that A, B, and C mean, for example, women's top, blouses, and checkered patterns, respectively.

The service server may assign, to the clustered image groups, labels, which may be interpreted ex post, such as women's bottom, skirt, one-piece dress, short sleeves, long sleeves, patterns, materials, colors, abstract feelings (innocent, chic, vintage, etc.), and extract labels assigned to an image group to which an individual product image belongs as a label of the corresponding product image.

On the other hand, the service server according to the embodiment of the present invention may express the label extracted from the product image as text, and the label in the text form may be used as tag information of the product.

Conventionally, the tag information of products is subjectively and directly provided by a seller, thus is inaccurate and has low reliability. There was a problem that a product tag subjectively given by the seller acts as a noise to lower search efficiency.

However, as in the embodiment of the present invention, when label information is extracted based on a product image and the extracted label information is converted into text and used as tag information of the product, the tag information of the product may be extracted mathematically without human intervention based on the image of a corresponding product, thus increasing the reliability of tag information and improving the accuracy of search.

Furthermore, the service server may generate category information of the corresponding product based on the contents of the product image. For example, when labels for a product image is extracted as female, top, blouse, linen, striped, long-sleeved, blue, or office look, the service server may use the labels for female, top, and blouse as category information of a corresponding product and use the labels for linen, stripe, long-sleeved, blue, and office look as label information to explain the characteristics of products out of categories. Alternatively, the service server may index the corresponding product without distinguishing the label and the category information. In this case, the category information and/or the label of a product may be used as a parameter for increasing the reliability of image search.

Accordingly, the service server may determine, as a recommended item, an item similar to the coordination item from the product database configured by indexing labels extracted from the described contents of products, and search the product database for a product similar to the recommended item to provide product information for the recommended item.

More specifically, the service server may search the product database based on an image similarity for the coordination item determined using the style database. To this end, the service server may extract the features of the coordination item object and index specific information of images for search efficiency.

The service server according to an embodiment of the present invention may search a product database based on the similarity of the object image. For example, the service server may calculate a similarity between feature values of a recommended item image and of a product image included in the product database, and determine a product having a similarity within a preset range as a recommended product.

Furthermore, the service server according to the embodiment of the present invention may process the feature values of the recommended item image by reflecting the weights required by the plurality of layers of an artificial neural network model for the machine learning configured for the product database, select at least one product group having a distance value within a predetermined range, and determine products belonging to the group as a recommended item.

Furthermore, the service server according to another embodiment of the present invention may specify a recommended product based on a label extracted from a recommended item object.

For example, when the label information of an object extracted from the recommended item image is extracted as women's top, blouse, white, and stripes, the service server may calculate a similarity with the search target object image only for the product group having the women's top as the category information in the product database.

As another example, the service server may determine products having a similarity greater than or equal to a preset range as recommended candidate products, and exclude products whose sub-category information is not a blouse from the recommended candidate products. In other words, products whose sub-category information is indexed with a blouse may be selected as an advertisement item.

As another example, when the label information extracted from the object image of the recommended item is women's top, blouse, long sleeve, lace, or collar neck, the service server may calculate the image similarity with the recommended item only for a group of products having women's top, blouse, long sleeve, lace, and collar neck as labels in the product database.

The service server sets priorities for at least one selected candidate item based on purchase patterns of users having a body type similar to that of a specific user among users that have used a checked online-shop, and provides a recommended product according to the set priorities (S130). In other words, it is possible to provide a more specific and intuitive recommendation service by grouping users with body types similar to the specific user and providing a product recommendation service according to the preference of the group, rather than simply setting priorities based on purchase patterns of general users.

Here, the service server may expose items that should be purchased together to a user device based on individual products contained in a shopping cart. For example, when individual products in the shopping cart are skirts and pants, recommended items may be exposed (e.g., in the form of a grid at the bottom of the page) in a part of the shopping cart page (e.g., at the bottom)

Alternatively, a priority may be set for each recommended item category based on a user preference database. That is, it is possible to preferentially sort products which have additionally purchased by people with a body type similar to a user who requested the recommendation service from the online-shop, rather than all previous purchasing customers of the online-shop. For example, it is possible to guide a recommended size in the online-shop according to size body type information, preferentially sort products which have additionally purchased by people with a body type similar to a user who requested the recommendation service from the online-shop, rather than all previous purchasing customers of the online-shop.

Furthermore, in the present invention, the service server may provide an option to recommend a recommended product or a coordination product in the form of a layer pop-up when a user who has requested a recommendation service clicks on a corresponding product without moving to a separate page such that the user does not leave the page and, when the user selects an option, enable an order to be immediately placed.

In addition, when the user decides to purchase the recommended product, the service server may transmit purchase information to an online-shop for the recommended product, and update user body type information and online-shop information extracted from the purchase information in the user preference database. That is, the review data of users who have used the checked online-shop may be converted into computer-readable data and updated in the user preference database.

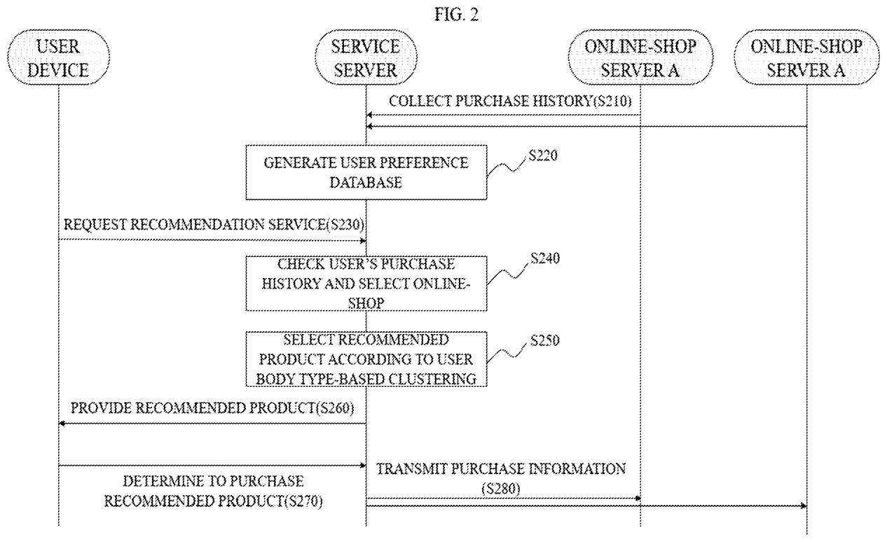

FIG. 2 is a flowchart for providing a recommendation service in a service server according to the present invention. In FIG. 2, the content repeating the content described with reference to FIG. 1 is replaced with the content described above.

The service server may collect purchase histories from external servers (e.g., a plurality of online-shops) (S210). That is, in order to extract user body type information, not only product purchase histories, but also purchase histories of users from online-shops, products viewed by users, or inquiry histories may be collected from an external online-shop server.

The service server creates a user preference database using a specific online-shop and the user body type information based on the collected purchase histories (S220).

When a request for a recommendation service is received from a user device, the service server may extract a style label and user body type information which are determined to be necessary for the user in relation to the recommendation service (S230).

The service server checks the purchase history of the user and selects an appropriate online-shop according to the style labels (S240). In this case, when the user's purchase history and the style label of the selected online-shop match each other, a recommended product is provided based on the corresponding online-shop. However, when the user's purchase history and the style label of the recommendation service do not match each other, the recommendation service may be provided by selecting an online-shop matching the corresponding style label.

The service server selects a clustered recommended product based on the user's body type information based on the selected online-shop (S250).

The service server provides the recommended product to the user device (S260), and determines whether the recommended product is purchased by the user device (S270). In this case, the service server may recommend a recommended product or a coordination product in the form of a layer pop-up when a user who has requested a recommendation service clicks on a corresponding product without moving to a separate page such that the user does not leave the page.

Accordingly, when the purchase of the recommended product is determined, the service server transmits purchase information for the recommended product to a corresponding online-shop (S280).

Hereinafter, the user fashion database of the present invention described above will be described.

The user fashion database may include information on fashion items, and may include sizes of fashion items, a label expressing a feeling that a person feels in a fashion item as computer-recognizable data, a photo when a user wears the fashion item, and the like. For example, the user fashion database may include information on the sizes of the user's top, bottom, dress, or the like, and the appearance of a user actually wearing clothing is managed as a photo, allowing the user to consider his/her body type. Alternatively, by storing personal feelings such as #comfortable, #tight, and #0K for each of the fashion items, the user may refer to it when considering fitting in the case of selecting a fashion item later. In addition, the user fashion database may include image information of when the user wears a fashion item, information based on which the user's taste is estimated, such as the user's purchase data and browsing time data, user size information, information on preferred price ranges, purposes, and brands in the case of online-shopping for fashion items.

Alternatively, the user fashion database may include user identification information, user behavior information for estimating a user size, a user size estimated from the behavior information, and user size information directly received from the user device.

For example, the service server may provide a user device with a query about the user's age, gender, occupation, fashion field of interest, previously owned item, or the like, receive a user input for the query, generate user size information, and reflect the user size information in the user fashion database.

The service server may generate taste information on a style that the user is interested in at that time by combining user behavior information for estimating user size, such as the time at which the user browsed any style book provided through an application according to the embodiment of the present invention, item information on which a like tag is created, a request item, fashion item information purchased through the application or other applications, time information at which the information is created, and reflect the taste information in the user fashion database.

In addition, the service server may generate user body type information and reflect the user body type information in the user fashion database. For example, when a user device generates body images by photographing a user's body from multiple angles and transmits the body images to the service server, the service server may create a user body type model using a machine learning framework that has learned human body features from a large number of body images. The user body type model may include information on the proportion of each part of the user body and skin tone as well as size information of each part of the user body.

According to an additional embodiment of the present invention, the service server may generate user preference information for fashion items and reflect the user preference information in the user fashion database. The preference information may include information on the user's preferred prices, preferred brands, and preferred purposes. For example, when a user browses or purchases a fashion item in an online market using a user device, the service server may generate information on the preferred prices, preferred brands, and preferred purposes by reflecting a weight differently for browsing or purchasing, and reflect the information in the user fashion database.

In particular, the service server according to an embodiment of the present invention may estimate the user's “taste” corresponding to a human feeling, generate the estimated taste information in a computer-recognizable form, and reflect the taste information in the user fashion database.

For example, the service server may extract a label for estimating the user's taste from the user's behavior information. The label may be extracted as meanings of fashion items included in the user behavior information, such as a style book browsed by the user, an item for which a like tag is generated, a request item, and a purchase item. Furthermore, the label may be generated as information on a look and feel, such as appearance and feeling related to fashion items included in the user behavior information, and trends.

The labels generated from the user behavior information is weighted according to the user behavior, and the service server may combine the labels to generate user size information for estimating the user's size and store it in the user fashion database. The user size information, the user body type information, and the user preference information included in the user fashion database may be used to set an exposure priority for a recommended item or a recommended product.

The embodiments of the present invention disclosed in the present specification and drawings are provided only to provide specific examples to easily describe the technical contents of the present invention and to aid understanding of the present invention, and are not intended to limit the scope of the present invention. It is obvious to those of ordinary skill in the art that other modifications based on the technical idea of the invention can be implemented in addition to the embodiments disclosed therein.

### INDUSTRIAL APPLICABILITY

The fashion item recommendation service using the user's body type and purchase history as described above can be applied to various service fields.

What is claimed is:

1. A method of providing a fashion item recommendation service to a user using a service server, the method comprising:
collecting histories of purchases through an online-shop and generating a user preference database by clustering user body type information and online-shop information from the purchase histories;
when receiving a request for a recommendation service from a specific user, checking online-shop information corresponding to the recommendation service based on a style label expressing a human feeling as computer-recognizable data;
performing collaborative filtering in the user preference database based on a fashion item size range determined based on the checked online-shop information and the user body type information to select at least one candidate item; and
setting a priority for the at least one selected candidate item based on purchase patterns of users having a body type similar to a body type of the specific user among users that have used the checked online-shop, and providing a recommended product according to the set priority.

2. The method of claim 1, further comprising:
when it is determined to purchase the recommended product, transmitting purchase information to an online-shop for the recommended product and updating user body type information and online-shop information extracted from the purchase information in the user preference database.

3. The method of claim 1, further comprising:
when receiving the request for the recommendation service, providing a coordination item by using a style database including style images from which the style label is extracted and a product database configured by indexing a label extracted from contents of products based on at least one of a product clicked by a user, a product purchased by a user, or a product in a user's shopping cart,
wherein the coordination item is provided together with a label of an item of another category determined from a style image including an item similar to the product purchased by the user, or is provided together with a coupon applicable when being purchased together with a product in the shopping cart.

4. The method of claim 3, wherein the coordination item is arranged and provided according to the priority set according to the purchase patterns of the users, based on the size range of the fashion items.

5. The method of claim 1, wherein the user preference database is updated by converting review data of users that have used the checked online-shop into computer-readable data.

6. The method of claim 1, wherein the online-shop information is clustered in the user preference database in a manner of being matched with a style label determined according to proportions of labels extracted from products sold in the online-shop.
